(19) United States
(12) Patent Application Publication
(10) Pub. No.: US 2023/0404854 A1
(43) Pub. Date: Dec. 21, 2023

(54) MEDICAMENT DISPENSING DEVICES AND METHODS THEREOF

(71) Applicant: Coherence Healthcare LLC, Cambridge, MA (US)

(72) Inventors: Justin Moore, Boston, MA (US); Ramalingam Konduru, Shrewsbury, MA (US); Daniel Johnson, Victoria (AU); Haris Brkic, Lukavac (BA)

(73) Assignee: Coherence Healthcare LLC, Cambridge, MA (US)

(21) Appl. No.: 18/212,129

(22) Filed: Jun. 20, 2023

Related U.S. Application Data
(60) Provisional application No. 63/353,111, filed on Jun. 17, 2022.

(51) Int. Cl. A61J 7/00

(52) U.S. Cl. CPC A61J 7/0076

(57) ABSTRACT

The application describes a device for providing a medicament includes a dispensing compartment, a medicament storage compartment adapted to store a medicament packaging containing the medicament, a transport mechanism adapted to transport the medicament packaging containing the medicament from the medicament storage compartment to the dispensing compartment, an opening station disposed within the dispensing compartment and adapted to open the medicament packaging containing the medicament while on the transport mechanism, an extruder disposed within the dispensing compartment and adapted to remove the medicament from the medicament packaging, and an outlet from which a user can receive the medicament. The device may provide medicament at a desired scheduled interval. The device may be adapted to open a medicament packaging and remove a medicament from the medicament packaging.

### CROSS-REFERENCE TO RELATED APPLICATIONS

This application claims priority to and the benefit of, and incorporates herein by reference in its entirety, U.S. Provisional Patent Application No. 63/353,111, which was filed on Jun. 17, 2022.

### TECHNICAL FIELD

In general, various embodiments of this invention relate to devices and methods for use in the dispensing of medicament from a device and, more specifically, to a dispensing device configured to deliver the medicament to a user and ensure compliance from the user.

### BACKGROUND

Compliance with taking medication according to a prescribed schedule and timing can be challenging for patients to adhere to resulting in suboptimal therapeutic effects. For example, if a patient fails to take their medication according to the timing prescribed by their healthcare provider, such as missing or taking their medication at a time later than recommended by their healthcare provider, the drug concentration in the patient's body may drop below the therapeutic effective level. Medications at drug concentrations below an effective subtherapeutic level may have reduced efficacy or lose efficacy altogether.

Further, some patients who take their medication at a time later than scheduled by their healthcare provider have too high a concentration of medication in their systems when taking the next dosage of medication as scheduled. This can lead to concentrations of drug at cytotoxic levels and result in adverse side effects for patients.

Some medication schedules can be difficult for patients to adhere to given their busy schedules throughout the day. In some instances, medications need to be taken multiple times a day or at irregular intervals making it difficult for patients to take their medication according to the prescribed schedule.

Compliance can particularly be an issue in populations of patients who are elderly and patients with mental health conditions. For example, elderly patients with Alzheimer's disease may forget to take medication at the scheduled time or forget whether they have already taken their medication at the scheduled time. In another example, individuals with mental health conditions such as depression, anxiety, or cognitive impairments may struggle with adhering to medication regimens due to difficulties such as motivation, memory, and/or organization.

Traditional medication compliance systems rely on a patient to write down and remember the dosage and schedule for taking medication. For example, “days of the week” medication containers include individual compartments designed to organize medications by each day typically for a week. In this system patients fill each of the compartments labeled with a day with the appropriate medications for each day, making it easier to keep track of what needs to be taken for each day. These containers, however, can be lost, patients can forget to fill them each week, patients can make mistakes filling each compartment for the week, and do not work for more complicated dosing regiments and schedules.

Other existing medication compliance technologies include alarms set for time periods when a patent should take their medication. However, these alarms can be confusing when a patient is taking more than one medication and may lead to the patient accidentally taking the wrong medication. Further, these alarm systems can be time consuming to set and open to human errors by accidentally entering the wrong schedule for taking the medication as directed by a healthcare provider. Moreover, traditional dispensing systems only dispense medication, but there is no tracking of the medication not taken or the reason for non-compliance.

In settings such as assisted living communities and healthcare systems it can be time consuming and costly for healthcare workers to verify and calculate a prescribed medication schedule for a patient. Further, in situations such as where a healthcare worker is caring for multiple patients and/or rotating with other health care workers, there is a risk for human error in providing the wrong medication or a medication not in compliance with a prescribed schedule.

Compliance may also be difficult for elderly patients and patients with physical health conditions because they may have challenges with the coordination, strength, and dexterity needed to remove medication from the medication packaging. Certain medication packaging is designed with child-resistant features to prevent accidental ingestion by children. Unfortunately, the child-resistant packaging can also create challenges for some patients to open the packaging, especially for patients with limited hand coordination, strength, and/or dexterity.

For example, patients with severe arthritis in their fingers sometimes may not have the necessary strength, coordination, or dexterity to hold a medication package while removing the medication. In another example, patients with visual impairments may have difficulty locating and identifying the medication or the correct medication within a medication packaging such as a blister pack. In some cases, the small size of the medication and the printed information or lack of visually impaired indicators on the packaging can pose challenges for individuals with vision problems.

Accordingly, need exists for an improved medication delivery device and method to provide a user with medication according to a prescribed schedule. Further, an opening station is needed to safely and effectively remove medication from medication packaging for the user.

### SUMMARY OF THE INVENTION

In various embodiments, the present invention relates to a device for providing medicament to a user. The device may have a dispensing compartment. The device may have a medicament storage compartment adapted to store a medicament packaging containing the medicament. The device may have a transport mechanism adapted to transport the medicament packaging containing the medicament from the medicament storage compartment to the dispensing compartment. The dispensing compartment may have an opening station therein. The opening station may be adapted to open the medicament packaging containing the medicament while the medicament packaging containing the medicament in on the transport mechanism. The device may have an extruder located within the dispensing compartment and adapted to remove the medicament from the medicament packaging. The device may have an outlet from which a user can receive the medicament.

In some instances, the dispensing compartment is in fluid communication with the medicament storage compartment. In some embodiments, the transport mechanism has a first conveyer and is adapted to control a position of the medicament packaging on the transport mechanism. In some embodiments, the transport mechanism has a second conveyer adapted to transport the medicament packaging from the dispensing compartment to the medicament storage compartment or to a disposal area.

In some cases, the opening station has a blade adapted to cut the medicament packaging. The opening station may have a camera system adapted to identify the medicament packaging and ensure the medicament packaging is positioned at a desired location relative to the blade. The camera system may be adapted to identify the medicament packaging.

In some embodiments, the extruder has a first cam and a second cam. In some embodiments, the device has a tray adapted to retain and load into the device the medicament packaging. The medicament packaging may be a plastic cell multidose sheet or a soft roll multidose pouches. The tray may be adapted to retain and load the medicament packaging into the device. For example, the medicament packaging loaded into the device may have a 7 day supply or a 28 day supply of medicament.

In some embodiments, the device has a user interface adapted to interact with the user. In some embodiments, the device has a vessel slot. The vessel slot may have a sensor adapted to detect the presence of a vessel within the vessel slot. The sensor may be adapted to dispense the medicament into the vessel when the vessel is detected within the vessel slot.

In general, in another aspect, embodiments of the invention feature a method of using a device for providing medicament. The method may include the steps of obtaining the device comprising a dispensing compartment, a medicament storage compartment adapted to store a medicament packaging containing the medicament, a transport mechanism adapted to transport the medicament packaging containing the medicament from the medicament storage compartment to the dispensing compartment, an opening station disposed within the dispensing compartment and adapted to open the medicament packaging containing the medicament while on the transport mechanism, an extruder disposed within the dispensing compartment and adapted to remove the medicament from the medicament packaging, and an outlet from which a user can receive the medicament. The method may include the step of interacting with the device to indicate a desire to receive medicament. The method may include the step of receiving the medicament from the outlet.

In some cases, the method includes the step of storing the medicament in the medicament storage compartment. In some embodiments, the dispensing compartment is in fluid communication with the medicament storage compartment.

In some embodiments, the method includes the step of loading the medicament packaging into a tray of the dispensing device The medicament packaging is loaded into a compartment selected from the group consisting of the medicament storage compartment and the dispensing compartment.

In some embodiments, the method includes the step of interacting with a user interface. For example, interacting with the user interface may include selecting the medicament to be dispensed from the user interface. In another example, interacting with the user interface may include entering side effects of the medicament into the user interface.

In some instances, the method includes removing a vessel containing the medicament from a vessel slot. The method may further include removing the medicament from the vessel. In some embodiments, the method may include the step of disposing the vessel empty of medicament in the vessel slot.

### BRIEF DESCRIPTION OF THE DRAWINGS

FIG. 1 illustrates a medicament dispensing device including a medicament storage compartment, a dispensing compartment, and an outlet according to an embodiment described herein.

FIG. 2 illustrates a medicament storage compartment according to an embodiment described herein.

FIG. 3 illustrates a first embodiment of medicament packaging as described herein.

FIG. 4 illustrates a second embodiment of medicament packaging as described herein.

FIG. 5 depicts a dispensing compartment according to an embodiment described herein.

FIG. 6 depicts a tray interfacing with the dispensing compartment of FIG. 5 according to an embodiment described herein.

FIG. 7 illustrates an embodiment of an extruder as described herein.

FIG. 8 illustrates a cross section of an interior of a dispensing compartment according to an embodiment described herein.

FIG. 9 illustrates a medicament dispensing system according to an embodiment described herein.

FIG. 10 illustrates a medicament outlet and a vessel according to an embodiment described herein.

FIG. 11 illustrates a user interface according to an embodiment described herein.

FIG. 12 illustrates a communication system for a medicament dispensing device according to embodiment described herein.

FIG. 13A illustrates a medicament dispensing system with a medicament packaging partially loaded into a transport mechanism according to an embodiment described herein.

FIG. 13B illustrates a medicament dispensing system with a medicament packaging interfacing with an opening station according to an embodiment described herein.

FIG. 13C illustrates a medicament dispensing system with a medicament packaging interfacing with a blade of an opening station according to an embodiment described herein.

FIG. 13D illustrates a medicament dispensing system with a medicament packaging interfacing with an extruder according to an embodiment described herein.

FIG. 13E illustrates a medicament dispensing system with a medicament packaging interfacing with an extruder and partially extruded by the extruder according to an embodiment described herein.

FIG. 13F illustrates a medicament dispensing system with medicament partially extruded from a medicament packaging interfacing with an extruder according to an embodiment described herein.

FIG. 13G illustrates a medicament dispensing system with medicament extruded from a medicament packaging, the medicament interfacing with an outlet according to an embodiment described herein.

FIG. 13H illustrates another view of the medicament dispensing system shown in FIG. 13A according to an embodiment described herein.

FIG. 13I illustrates another view of the medicament dispensing system shown in FIG. 13A according to an embodiment described herein.

FIG. 14 illustrates an example of a generic computing device, which may be used with the techniques described in this disclosure.

### DETAILED DESCRIPTION

Systems, methods, and devices described herein relate to accurately dispensing single and multidose packed medicament at the required time intervals. Dispensing of medicament may be done automatically to improve adherence to a directed schedule. Further, dispensing systems, methods, and devices may be configured to open medicament packaging for users, reducing challenges associated opening medicament packaging.

Systems, methods, and devices described herein relate to monitoring patient behavior to verify that medicament was actually taken (in addition to being dispensed). For example, the verification may include the use of neural network (NN) fusion of video, radio-frequency (RF), and/or Wi-Fi. In an example using NN, each subsystem is a smaller NN, with an overriding NN to fuse the data and confirm adherence.

Other systems, methods, and devices described herein relate to feedback loops to facilitate a behavior modification program. For example, implementing data from a monitoring system may be used for a medicament dispensing device to generate feedback to the user. Feedback may be transmitted in audio/visual cues, prizes, or other incentives to reward adherence and change behavior patterns.

Embodiments described herein relate to systems, methods and devices for medicament return and monitoring systems. For example, unwanted medicament may be returned to a medicament dispensing device. When returning medicament, the reasons for the return may be logged, such as unpleasant side effects. Further, embodiment described herein are related to systems, methods, and devices for cloud based software systems, which provides dashboard information (adherence data and metrics) to healthcare providers and users.

Automated multidose medicament dispensing systems may be targeted towards demonstrably improving adherence to a directed medicament regimen. To achieve compliance with taking medicament dispensing systems may dispense of medicament doses at the prescribed times for the user, verify that the medicament is actually taken by the patient, and track medicament that the user refuses to take, report compliance history back to healthcare providers, and modify behavior.

Systems, methods, and devices may be used in combination to achieve behavior modification and improve user compliance with taking medication. For example, a communication link may be used to transmit data from a dispensing device to be analyzed and passed through a machine learning algorithm along with user details and history to help qualify the methods which may be most effective in motivating a user and to modify their behavior. For instance, identifying specific days where a dose is consistently missed (a regular morning appointment), and by analyzing the movement patterns around the dispensing device may identify that the medication should be dispensed 1 hour earlier on that day. Behavior modification is not limited to simple timing changes but may also include more targeted user interaction with the equipment, for example reward messages and sounds from the device (similar to those used by casinos in electronic gaming machines), through to entries in competitions (with other users), or lotteries to reward consistent good compliance. This may allow healthcare providers to quickly identify problems with medicaments for the user and make adjustments to their medicament regimen, with the goal of eliminating/reducing the adverse side effect, and consequently boosting adherence, improving outcomes overall for the user (fewer side effects while receiving the benefit of taking the medicament as prescribed).

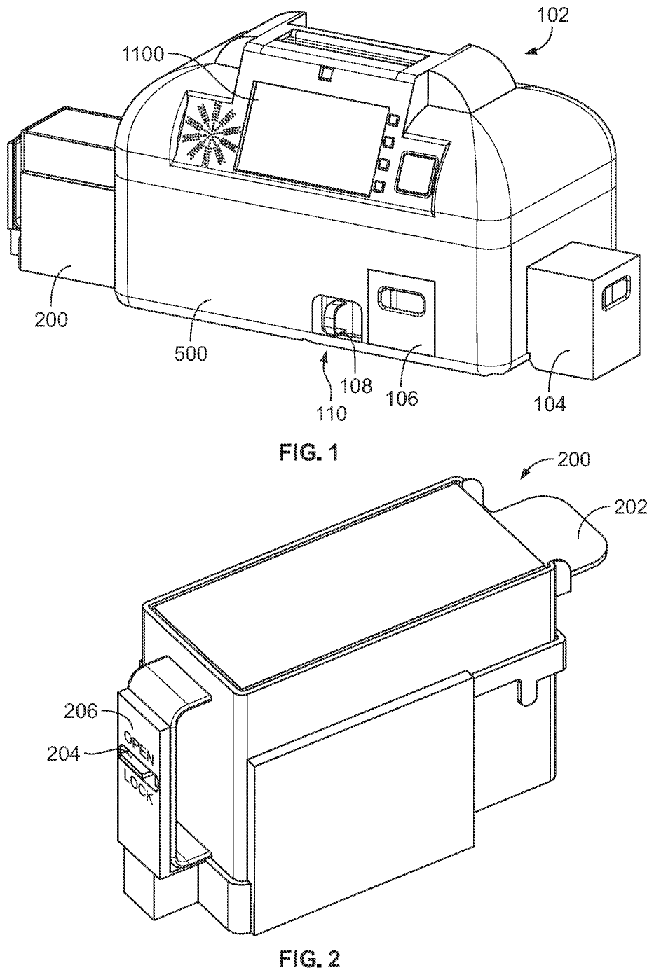

FIG. 1 illustrates a medicament dispensing device 102 having a medicament storage compartment 200, medicament dispensing device 102, an outlet 104, and an inlet 106. according to an embodiment herein. In some embodiments, the medicament dispensing device 102 is configured to be mounted on a desktop. In some embodiments, the medicament dispensing device 102 is configured to detachably couple with a vessel 108. The vessel 108 may be adapted to retain medicament. The medicament dispensing device 102 may be configured to deposit medicament into a vessel 108. In some embodiments, the vessel 108 is configured to detachably couple at least partially within a vessel slot 110.

In some embodiments, the medicament dispensing device 102 has a user interface 1100. In some embodiments, the outlet 104 is a waste outlet from the machine. For example, outlet 104 may be configured to couple with a waste bin configured to retain medicament packaging empty of medicament. In some embodiments, the inlet 106 is configured to receive medicament. In some embodiments, inlet 106 is configured to receive unwanted medicament. For example, the medicament dispensing device 102 may have a “skip medicament mode” where the inlet 106 is a medication return bin configured to receive medicament securely if a user decides not to not take medicament due to side effect and/or missing the scheduled timeframe for taking the medicament.

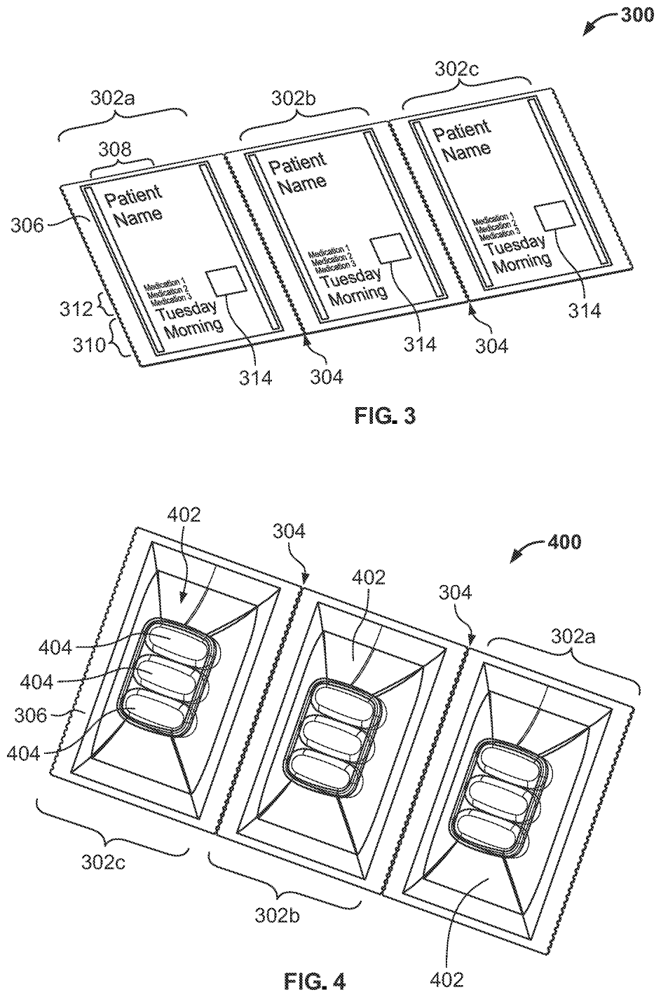

FIG. 2 illustrates a medicament storage compartment 200 according to an embodiment described herein. In some embodiments, the medicament storage compartment 200 is a roll container configured to retain at least one roll of medicament packaging. In another non-limiting example, the medicament storage compartment 200 is configured to retain at least one medicament packaging, the medicament packaging in the form of a multidose plastic cell sheet. In some embodiments, the medicament packaging is placed in the medicament storage compartment 200 such that a portion or a pouch of the medicament packaging protrudes from the storage outlet 202. In some embodiments, the medicament storage compartment 200 is in fluid communication with the medicament dispensing device 102. In one non limiting example, the storage outlet 202 of the medicament storage compartment 200 opens into the interior of the medicament dispensing device 102.

In some embodiments, the medicament storage compartment 200 is configured to accept additional medicament packaging while the first medicament packaging is transported to the medicament dispensing device 102. One selected from the group consisting of the medicament dispensing device 102 and the medicament storage compartment 200 may be configured to draw a portion of the medicament packaging from the medicament storage compartment 200 into the medicament dispensing device 102.

In some embodiments, the medicament storage compartment 200 is detachably coupled to the medicament dispensing device 102. The dispensing compartment may include a lock 204 configured to secure the medicament storage compartment 200 to the medicament dispensing device 102. In one non-limiting example, the lock 204 may secure the medicament storage compartment 200 to the medicament dispensing device 102 to prevent the medicament storage compartment 200 from accidentally dislodging from the medicament storage compartment 200. In some embodiments, the lock 204 is configured to slidably move from a locked position to an unlocked position. In some embodiments, the medicament storage compartment 200 or the medicament dispensing device 102 has a sensor configured to detect when the medicament storage compartment 200 is interfacing with the medicament dispensing device 102 and trigger the lock 204 to automatically move into a locked position. In some embodiments, the lock 204 is a mechanical lock configured to automatically move into a locked position when the medicament storage compartment 200 interfaces with the medicament dispensing device 102.

In some embodiments, the medicament storage compartment 200 may have a dispensing compartment handle 206. In some embodiments, the lock 204 is located on the dispensing compartment handle 206. In other embodiments the medicament storage compartment 200 and the medicament dispensing device 102 are a single component. In some embodiments, the medicament storage compartment 200 is configured to retain medicament packaging in different forms and from different brands.

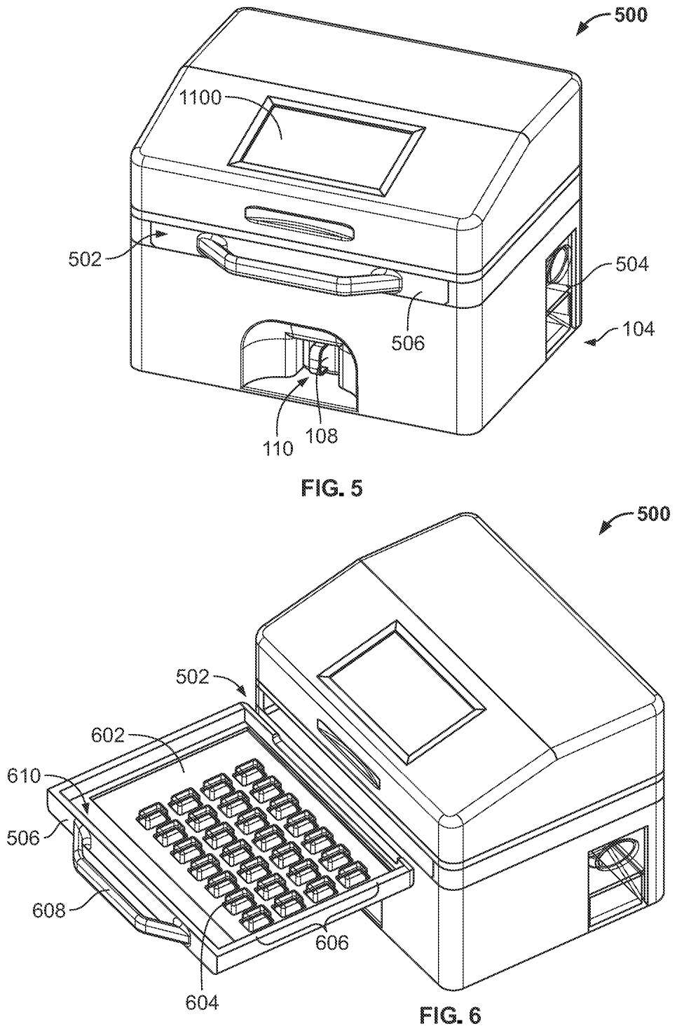

FIG. 3 illustrates a first embodiment of medicament packaging 300. For example, the medicament packaging 300 illustrated in FIG. 3 has connected in series a first medicament packaging cell 302a, a second medicament packaging cell 302b, and a third medicament packaging cell 302c. The medicament packaging 300 may have any number of medicament packaging cells connected to one another. In some embodiments, the medicament packaging cells are separated by a perforation 304 in an outer medicament packaging edge 306 of the packaging.

In some embodiments, the medicament packaging 300 includes at least one label. In some embodiments, the medicament packaging 300 includes at least one of a patient information label 308, medicament dosage schedule label 310, medicament information label 312, QR code 314, or any combination thereof. For example, the patient information label 308 may include information related to which user the medicament contained within a medicament packaging cell will be dispensed to. In another example, the medicament information label 312 includes information on the type and/or dosage of the medicament contained within the medicament packaging cell. The medicament dosage schedule label 310 may include information such as the day and time for which the medicament should be dispensed to the user.

In some embodiments, the medicament packaging 300 includes a camera (not shown) configured to capture the one or more labels on the medicament packaging 300. The camera may transmit the information from the medicament label to a processor (not shown). In some embodiments, the processor directs dispensing of medicament based on information provided by the one or more labels on the medicament packaging 300.

In some embodiments, the medicament packaging 300 comprises of a soft plastic and/or paper pouch or medicament packaging cell. In some embodiments, the medicament packaging 300 cells are configured to have dimensions larger than the dimensions of the medicament within the cells. In one non-limiting example, the medicament packaging 300 has dimensions of 3 inches in length and 2 inches in width. In some embodiments, the medicament packaging cell is configured to retain a plurality of medicament. For example, the medicament packaging cell may retain all medication for a user that the user has been scheduled to take in the morning. Consolidating medication scheduled to be taken at the same time may provide a cost effective solution and reduces the risk of missed dosages of medication.

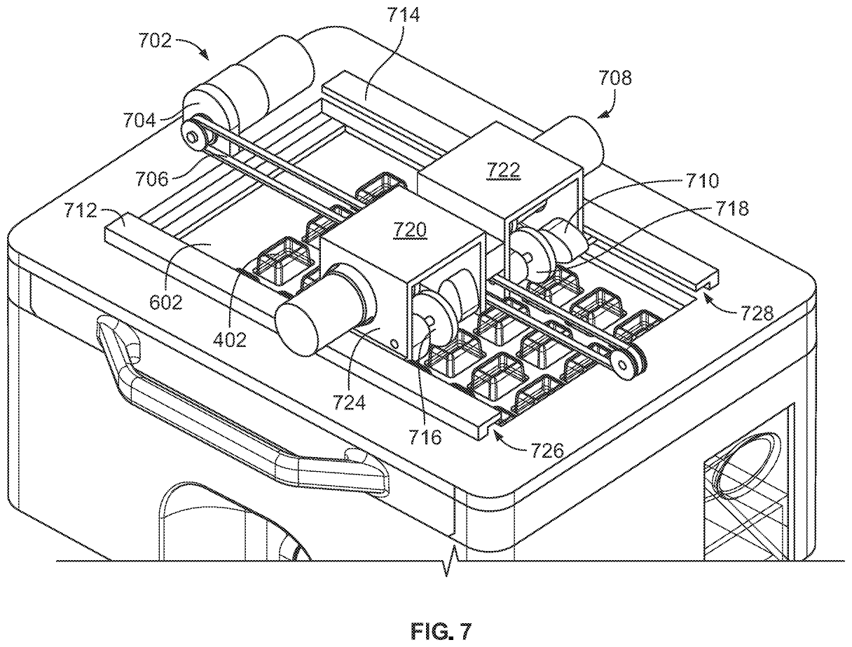

FIG. 4 illustrates a second embodiment of medicament packaging containing medicament 400. The medicament packaging containing medicament 400 may include one or more medicament packaging cells 302a, 302b, 302c. Each medicament packaging cell may include a medicament packaging cavity 402 configured to retain medicament 404. For example, the medicament packaging cavity 402 may form a generally convex inner surface configured to retain one of more medicaments 404. In one non-limiting example, the medicament packaging containing medicament 400 is a bister medicament package.

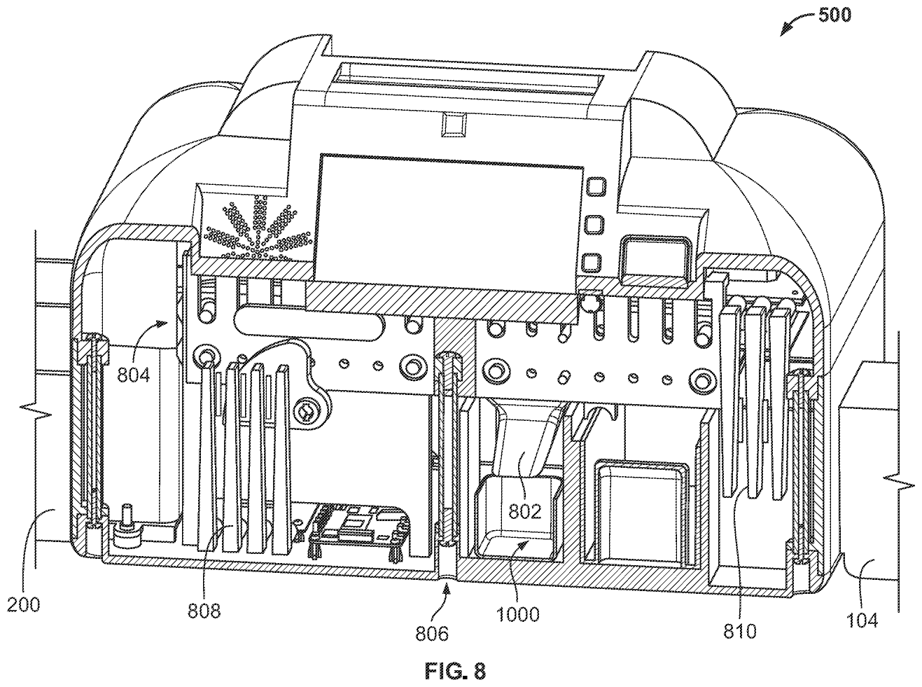

FIG. 5 depicts a medicament dispensing compartment 500 having an inlet 502. In a non-limiting example, the medicament dispensing compartment 500 may have general dimensions of 18 inches wide, 8 inches depth, and 10 inches high. In another non-limiting example, the medicament dispensing compartment 500 may have general dimensions of 12 inches wide, 10 inches depth, and 10 inches high. In some embodiments, the medicament dispensing compartment 500 includes an outlet 104 and/or a medicament return inlet 504.

In some embodiments, the inlet 502 is configured to load medicament packaging into a medicament dispensing device 102. In some embodiments, the inlet 502 is configured to at least partially retain a tray 506. In some embodiments, the medicament dispensing device 102 includes a plastic container for holding cassette type tray for loading the medicament packaging into the medicament dispensing device 102. In some embodiments, the inlet 502 is a slot having dimensions larger than the portion of the tray 506 disposed within the inlet 502. In some embodiments, the inlet 502 is located on the same side of the medicament dispensing device 102 as the user interface 1100 and the medicament return inlet 504.

In some embodiments, the outlet 104 is configured to permit medicament packaging empty of medicament exit the medicament dispensing device 102. In some embodiments, the medicament dispensing device 102 has a medicament return inlet 504. The medicament return inlet 504 may be configured to permit unused or unwanted medicament to be deposited back into the medicament dispensing device 102 for storage.

In some embodiments, the medicament return inlet 504 is a slot, a hole, a tray, or any other inlet capable of permitting medicament to enter the medicament dispensing device 102. In some embodiments, the medicament dispensing device 102 has an unused medicament return container incorporated within it. The medicament return inlet 504 may be configured to facilitate medicament disposed through the medicament return inlet 504 to be deposited in the unused medicament return container. For example, the medicament dispensing device 102 may have an opening funnel connecting the medicament return inlet 504 with the unused medicament return container. In some embodiments, the funnel has a medicament return sensor configured to detect medicament passing through the opening of the funnel. In some embodiments, the medicament return inlet 504 has a medicament return sensor configured to detect when medicament passes through the opening of the medicament return inlet 504. In some embodiments, the signal from the sensor is sent to a processor to count each medicament returned to the medicament return inlet 504. In some embodiments, when returned medication is detected by the medicament return sensor, the user interface 1100 is configured to prompt a response from the user. For example, the prompt from the user may comprise selecting from a list of reasons why the medication was not taken and logging the selection in the system.

In some embodiments, the medicament dispensing device 102 is configured to seal the unused medicament return container. For example, the medicament dispensing device 102 may apply an anti-tamper seal to the unused medicament return container. In some embodiments, the medicament dispensing device 102 is configured to monitor the amount medicament has been returned. In some embodiments, when the unused medicament return container is full, the user interface 1100 will display a prompt to remove the full unused medicament return container and replace it with an empty unused medicament return container. In some embodiments, the full unused medicament return container is configured to fit within a replacement return container (not shown).

In some embodiments, the medicament dispensing compartment 500 comprises a vessel slot 110. In some embodiments, a vessel 108 is configured to be disposed at least partially within the vessel slot 110. In some embodiments, the vessel 108 is adapted to retain medicament dispensed from the medicament dispensing compartment 500. In some embodiments, the vessel slot 110 has a vessel slot sensor adapted to detect the presence of a vessel 108 in the vessel slot 110. In some embodiments, the vessel slot sensor is coupled with a processor configured to dispense medicament from the medicament dispensing compartment 500 to the vessel 108 only when the vessel 108 is detected within the vessel slot 110. In some embodiments, the vessel 108 is also fitted at least one radio-frequency identification (RFID) tag configured to actively track the vessel 108 when the vessel 108 is removed from the vessel slot 110.

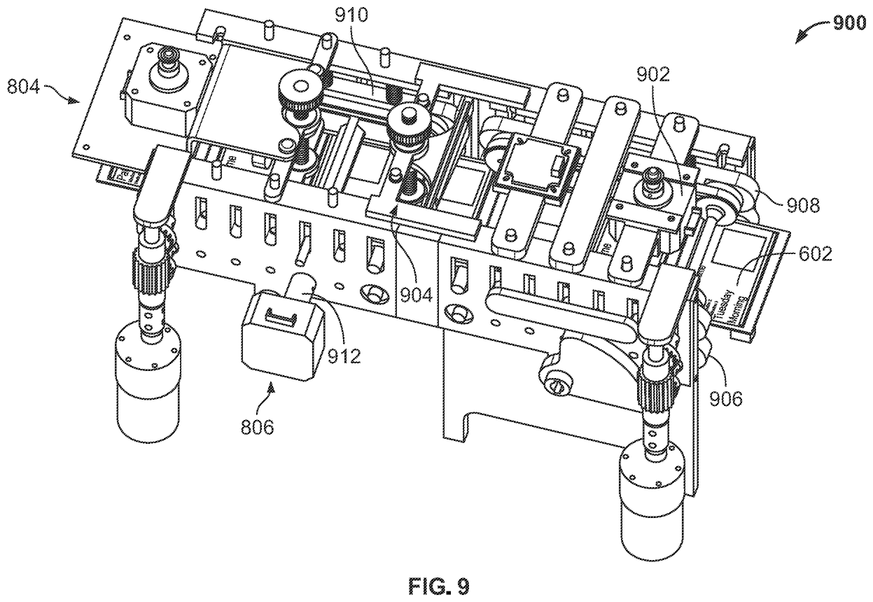

FIG. 6 depicts a tray 506 disposed within an inlet 502 of a medicament dispensing device 102. In some embodiments, the medicament dispensing device 102 is configured to dispense medicament from a medicament packaging 602. The medicament packaging 602 may be a plastic cell multidose sheet. In a non-limiting example, the plastic cell sheet may be a blister pack. In some embodiments, the medicament packaging may be a soft roll multidose pouch. In some embodiments, the medicament packaging 602 includes at least one medicament packaging cell 604. In some embodiments, the medicament packaging 602 includes a plurality of medicament packaging cell 604 arranged in a medicament packaging cell array 606.

In some embodiments, the medicament dispensing device 102 has a first dispensing mechanism for medicament packaging 602 in soft roll multidose pouches. In some embodiments the medicament dispensing device 102 has a second dispensing mechanism for medicament packaging 602 in plastic cell sheets. In some embodiments, the first dispensing mechanism and the second dispensing mechanism share medicament delivery and adherence tracking approaches. In some embodiments, the tray 506 is a structure fitted with a handle 608 configured to facilitate opening and closing of the tray 506 within the medicament dispensing device 102. In some embodiments, the handle 608 extends from a first end to a second end of the tray 506. In some embodiments, the handle 608 extends over a portion of the tray 506 for a length less than the length of the tray 506. In some embodiments, the handle 608 is a knob or a single grip. In some embodiments, the tray 506 comprises a plastic material.

In some embodiments, the tray 506 is configured to engage or interface with an inlet 502. In some embodiments, the tray 506 is at least partially disposed within the inlet 502. In some embodiments, the inlet 502 is mechanically keyed to ensure that the tray 506 can only be inserted into the medicament dispensing device 102 in a desired orientation.

The tray 506 may include a tray keyed region 610 configured to ensure alignment with the medicament packaging 602. In one non-limiting example, the tray keyed region 610 is a recess configured to fit the outside dimensions of the medicament packaging 602. In another non-limiting example, the tray keyed region 610 is configured to fit the specific medicament packaging cell array 606 of the medicament packaging 602. For example, the tray keyed region 610 may have recesses configured in groups of 28 to fit a medicament packaging 602 containing medicament packaging cell 604 in a 28 day dosage. In another example, the tray keyed region 610 may have recesses configured in groups of 7 or 10 to fit a medicament packaging 602 containing medicament packaging cell 604 in a 7 or 10 day dosage respectively. Incorrect loading of the medicament packaging 602 may prevent the tray 506 from being inserted into the medicament dispensing device 102 or the medicament from being removed from medicament packaging cell 604. Correct loading of the medicament packaging 602 into the tray 506 may help to ensure the correct dose for the correct day is dispensed.

In some embodiments, the tray 506 is secured within the inlet 502 of the medicament dispensing device 102 with a dispensing compartment tray lock (not shown). The dispensing compartment tray lock may be an electromagnetic lock. In a non-limiting example, the inlet 502 may be located in the medicament dispensing compartment 500. The dispensing compartment tray lock may prevent the tray 506 from decoupling from the medicament dispensing device 102 when in a locked position. For example, the dispensing compartment tray lock may prevent the medicament packaging 602 from being removed from the medicament dispensing device 102 by a child or someone other than the user. In some embodiments, the dispensing compartment tray lock will automatically move into a locked position to secure the tray 506 within the inlet 502 until all doses have been dispensed and/or the medicament packaging 602 needs to be replaced.

In some embodiments, the tray 506 is configured to have a manual eject override for the dispensing compartment tray lock to permit the tray 506 to be manually removed from the inlet 502. For example, if a user needs access to the medicament packaging 602 they may use the manual eject override to deactivate the dispensing compartment tray lock to decouple the tray 506 from the inlet 502. In some embodiments, an automatic eject override is triggered to move the dispensing compartment tray lock into an unlocked position and decouple the tray 506 from the inlet 502. In one non-limiting example, the automatic eject override may be triggered in the event of power failure, such that the dispensing compartment tray lock may automatically disengage into an unlocked position, allowing the tray 506 to be removed from the inlet 502. This may allow a user to continue taking regular medicine until such time as power is restored and the medicament dispensing device 102 can continue to be used.

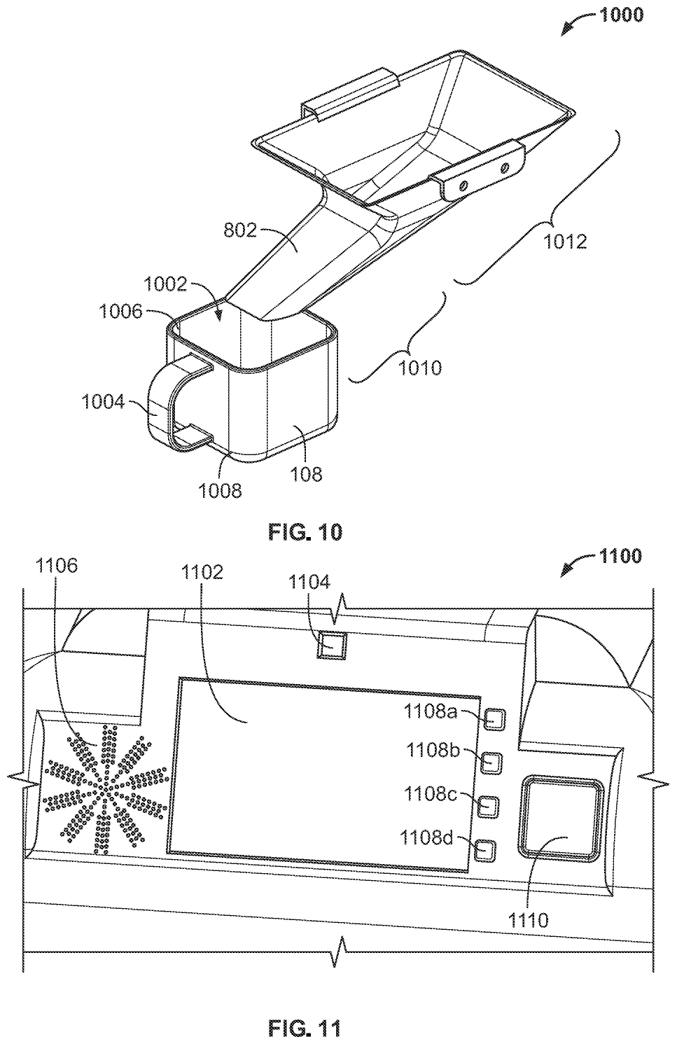

FIG. 7 illustrates an embodiment of an extruder 702 configured to remove medicament from one or more medicament packaging 602. In some embodiments, the extruder 702 has a first motor 704, an extruder conveyer 706, a compression station 708, a keyed portion 710, a first extruder track 712, and a second extruder track 714.

In some embodiments, the medicament dispensing device 102 is configured to open each cell in the medicament packaging 602 with an extruder 702. In some embodiments, the extruder 702 is an electromechanical mechanism. In some embodiments, the extruder 702 is configured to remove medicament from a medicament packaging 602 at scheduled times and dates.

in some embodiments, the extruder 702 has a compression station 708 including at least one first wheel 716 or a cam configured to crush the back of each cell, causing a portion of the medicament packaging 602 to tear and the medicament to be released from the medicament packaging cavity 402. The medicament may pass through the now broken portion of the medicament packaging 602 to an outlet under gravity. For example, the first wheel 716 may crush the medicament packaging cavity 402 and/or the medicament packaging 602, causing a foil seal portion (not shown) of the medicament packaging 602 to tear. In some embodiments, the compression station 708 has a second wheel 718 configured to crush one or more medicament packaging cavity 402. In some embodiments, the first wheel 716 and the second wheel 718 are configured to crush medicament packaging cavity 402 in a first medicament packaging and a second medicament packaging. For example, the first wheel may crush a medicament packaging cavity 402 to release a first type or dosage of medicament at the same time as the second wheel 718 crushes a different medicament packaging cavity 402 to release a second type or dosage of medicament allowing the user to receive more than one type or dosage of medicament.

In some embodiments, the extruder 702 includes a first motor 704, a second motor 720, and a third motor 722. In some embodiments, the second motor 720 and the third motor 722 are mounted with a motor carriage 724. In some embodiments, the second motor 720 and the third motor 722 are each mounted to a respective first wheel 716 and second wheel 718. In some embodiments, the first motor 704 is mounted as a unit in a carriage mechanism. In some embodiments, the motors 704, 720, and 722 are arranged in combination with the wheels 716 and 718 to provide dispensing of medicament at up to four different times during the day. In a non-limiting example, the extruder 702 may be configured to dispense medicament with the wheels 716 and 718 in combination with the motors 704, 720, and 722 at timepoints of morning, midday, afternoon, and evening. The second motor 720 may be arranged with the first wheel 716 to provide dispensing at a first timepoint. The second motor 720 may be arranged with the second wheel 718 to provide dispensing at a second timepoint. The third motor 722 may be arranged with the second wheel 718 to provide dispensing a third timepoint. The third motor 722 may be arranged with the second wheel 718 to provide dispensing a fourth timepoint. The first timepoint, the second timepoint, the third timepoint, and the fourth timepoint may be delivered in any order.

In some embodiments, first motor 704 is the ‘day’ drive and is used to move the motor carriage 724 along the medicament packaging 602, aligning the motor carriage 724 with each ‘day’ in the medicament packaging 602. In some embodiments, the motor carriage 724 is configured to be placed in a neutral position, such that the ‘day’ drive can traverse across the medicament packaging 602 without dispensing the medicament. In some embodiments, all first motor 704, second motor 720, and the third motor 722 are fitted with rotary position encoders to provide closed loop control over the first wheel 716, the second wheel 718, and tray 506 positions.

The first motor 704 may be mounted to a portion of the medicament dispensing device 102 and mounted as a unit in a carriage mechanism. In some embodiments, the second motor 720 and the third motor 722 are bi-directional. In some embodiments, each of the second motor 720 and the third motor 722 are coupled with a pair of wheels or cams. For example, rotating the second motor 720 of the third motor 722 forward engages a front wheel or cam and rotating backwards engages a back wheel or cam.

In some embodiments, the motor carriage 724 includes one or more keyed portions 710 configured to interface with extruder track first groove 726 and the extruder track second groove 728 to maintain the position of the motor carriage 724 relative to the medicament packaging 602. In some embodiments, the motor carriage 724 is configured to move along the medicament packaging 602 due to rotation of an extruder conveyer 706 by a first motor 704.

In some embodiments, there is a neutral “home” position for each second motor 720 and third motor 722 at a position where no wheels are engaged with the medicament packaging 602. For example, this may permit the wheels to move along the medicament packaging 602 without touching a medicament packaging cavity 402. The neutral position may be configured to for a single medicament packaging cavity 402 or multiple medicament packaging cavities 402 to be started any time of day and for doses to be skipped.

In some embodiments, each motion axis is equipped with home position limit switches (not shown). The “home” position limit switches may be configured to reset the position of the motors when a reset event is triggered. In one non-limiting example, the reset event may be a loss of power where resetting the position of the motors ensures that medication is not accidentally dispensed during re-homing sequences.

In some embodiments, at least one of the first motor 704, the second motor 720, and the third motor 722 are coupled with motor sensors to monitor current and/or torque. The motor sensors may be adapted to detect the drive torque during dispensing operation. In some cases, as the first wheel 716 engages with the medicament packaging cavity 402, there is an increase of drive torque during engagement. The drive torque detected by the motor sensors may fall suddenly when the medicament packaging cavity 402 has been ruptured.

In some embodiments, a motor sensor detecting the motor current is configured to transmit torque and/or current data to a processor. The processor may transmit the torque and/or current date to a machine learning neural network. For example, the learning neural network may be configured to use artificial intelligence and/or machine learning to determine if the medicament packaging cavity 402 and/or the medicament packaging 602 opened correctly and released the medicament.

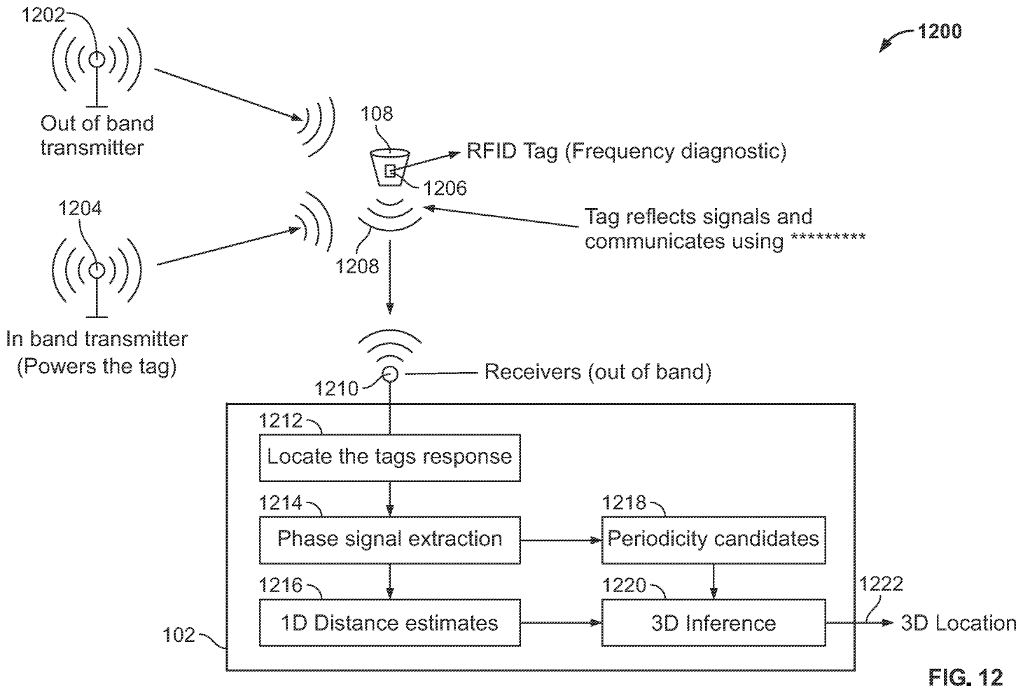

FIG. 8 illustrates a cross section of an interior of a medicament dispensing compartment 500 according to an embodiment described herein. In some embodiments, the medicament dispensing compartment 500 includes a medicament outlet 1000 and an outlet chute 802. In some embodiments, the outlet chute 802 is at a location beneath a transport mechanism 804. In some embodiments, the transport mechanism 804 is configured to move the medicament packaging to a location above the medicament outlet 1000. In some embodiments, the transport mechanism 804 transports medicament packaging to an opening station 806 configured to remove medicament from the medicament packaging to permit the medicament to pass through the medicament outlet 1000.

In some embodiments, the medicament dispensing compartment 500 includes one or more RF antennas. For example, the medicament dispensing compartment 500 may comprise a first RF antenna 808 and a second RF antenna 810. In some embodiments, the first RF antenna 808 and the second RF antenna 810 each may comprise a plurality of antenna. In some embodiments, the first RF antenna 808 is located adjacent to one end of the medicament dispensing compartment 500 and the second RF antenna 810 is located adjacent to a second end of the medicament dispensing compartment 500 opposite the first end of the medicament dispensing compartment 500.

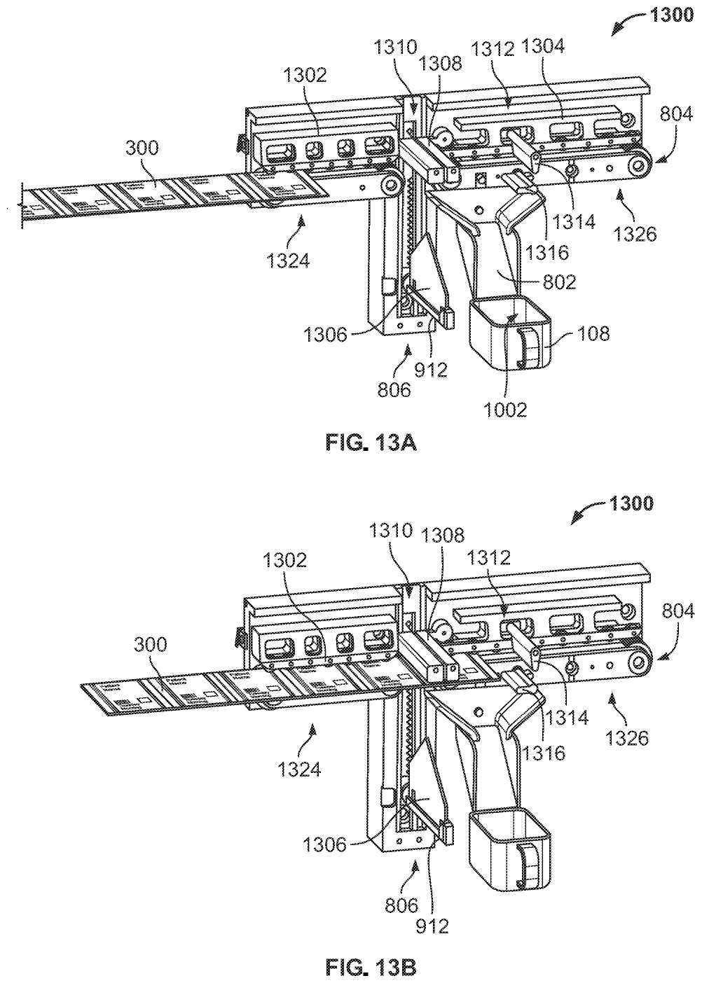

FIG. 9 illustrates a medicament dispensing system 900 having a transport mechanism 804, a camera system 902, an extruder 904, and an opening station 806.

In some embodiments, the opening station 806 in combination with the extruder 904 is configured to open medicament packaging 602 to dispense medicament at a scheduled time and date. In some embodiments, the opening station 806 and the extruder 904 are electromechanical mechanisms.

In some embodiments, the transport mechanism 804 comprises at least one conveyer. In some embodiments, the transport mechanism 804 has a first infeed conveyer 906, a second infeed conveyer 908, a first outfeed conveyer 910 and a second outfeed conveyer (not shown). In some embodiments, the transport mechanism 804 comprises a series of conveyors to transport the medicament packaging 602 within the medicament dispensing compartment 500. In some embodiments, one or more actuator stations are located along the transport mechanism 804, wherein the actuator stations are configured to manipulate the medicament packaging 602 within the medicament dispensing device 102. In some embodiments, the first infeed conveyer 906 and the second infeed conveyer 908 are configured to be controlled independently of the outfeed conveyer 910. In some embodiments, the first infeed conveyer 906, the second infeed conveyer 908, and the outfeed conveyer 910 are configured to be controlled by a DC electric motor (not shown) with encoder feedback, allowing for speed control and position control (for positioning the medicament packaging 602 relative to the actuators in the machine). In some embodiments, the first infeed conveyer 906 and the second infeed conveyer 908 are configured to run synchronously with the and the outfeed conveyer 910 such that a medicament packaging 602 passes from the infeed conveyers to the outfeed conveyers.

In some embodiments, the first infeed conveyer 906 and second infeed conveyer 908 are configured to transport the medicament packaging from a medicament storage compartment 200 to the medicament dispensing compartment 500. In some embodiments, the first infeed conveyer 906 and second infeed conveyer 908 are configured to detect the position of each medicament packaging cell.

In some embodiments, a camera system 902 comprising an internal ID camera is mounted above the first infeed conveyer 906 and second infeed conveyer 908. In some embodiments, the camera system 902 is configured to detect the medicament packaging 602 and position of the medicament packaging 602. In some embodiments, the camera system 902 is configured to capture one or more labels printed on the medicament packaging 602. In some embodiments, the camera is configured to capture label information on the medicament packaging 602 and to identify the positioning of the medicament packaging 602 on the infeed conveyers. In some embodiments, the camera system 902 is adapted to capture one or more labels printed on the medicament packaging 602 and detect reference features in the artwork or label to determine the position of the medicament packaging 602 on the transport mechanism 804. The camera system 902 may be adapted to use the medicament packaging 602 label and determined position to communicate with the transport mechanism 804 to transport the medicament packaging 602 to a desired location relative to the extruder 904 and opening station 806. For example, the desired location may be beneath a blade of the opening station 806 or through the extruder to remove medicament from the medicament packaging 602.

In some embodiments, the position of the medicament packaging 602 information is used with the transport mechanism 804 to control one or more conveyers to fine tune the medicament packaging 602 position during the opening process. For example, the positioning with information from the camera system 902 provides input in a feedback loop to reduce the risk of cutting the medicament within the medicament packaging 602.

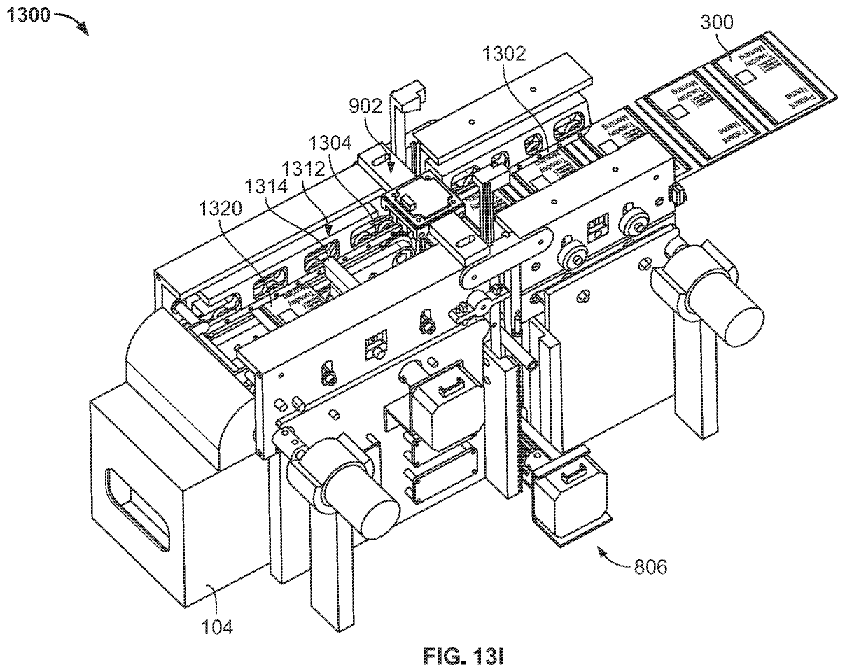

In some embodiments, when the position of the medicament packaging 602 is determined, the infeed conveyers are configured to transport the medicament packaging 602 to a position under the opening station 806. In some embodiments, the opening station comprises a cutter (See FIG. 13A-G) configured to open the medicament packaging 602. For example, the opening station may move the cutter into a position to cut along the perforation 304 between medicament packaging cells 604. In another example, the transport mechanism 804 is configured to transport the medicament packaging 602 to an outlet 104 if a dose was missed and the pouch is directed to be discarded into an unused medication bin. In some embodiments, the opening station 806 is configured to cut along the perforation 304 of medicament packaging 602 to separate a portion of the medicament packaging 602 directed to be removed from the machine. For example, if a user planned to use the medicament at a later time, the medicament dispensing device 102 would cut along the perforation 304 to separate a portion of medicament so the portion is able to be removed from the medicament dispensing device 102.

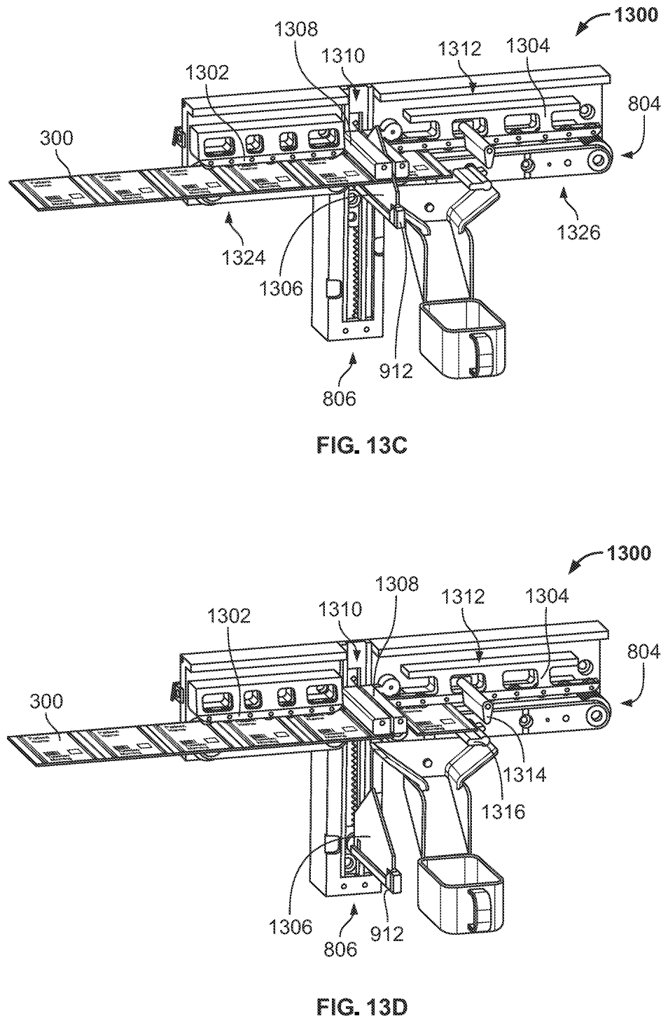

FIG. 10 illustrates a medicament outlet 1000 and a vessel 108 according to an embodiment described herein. In some embodiments, the medicament outlet 1000 includes an outlet chute 802 positioned directly over a vessel 108 such that medicament passing through the outlet chute 802 will be deposited within the vessel cavity 1002 of the vessel 108. In some embodiments, the medicament passes through the outlet chute 802 and into the vessel 108 due to gravity.

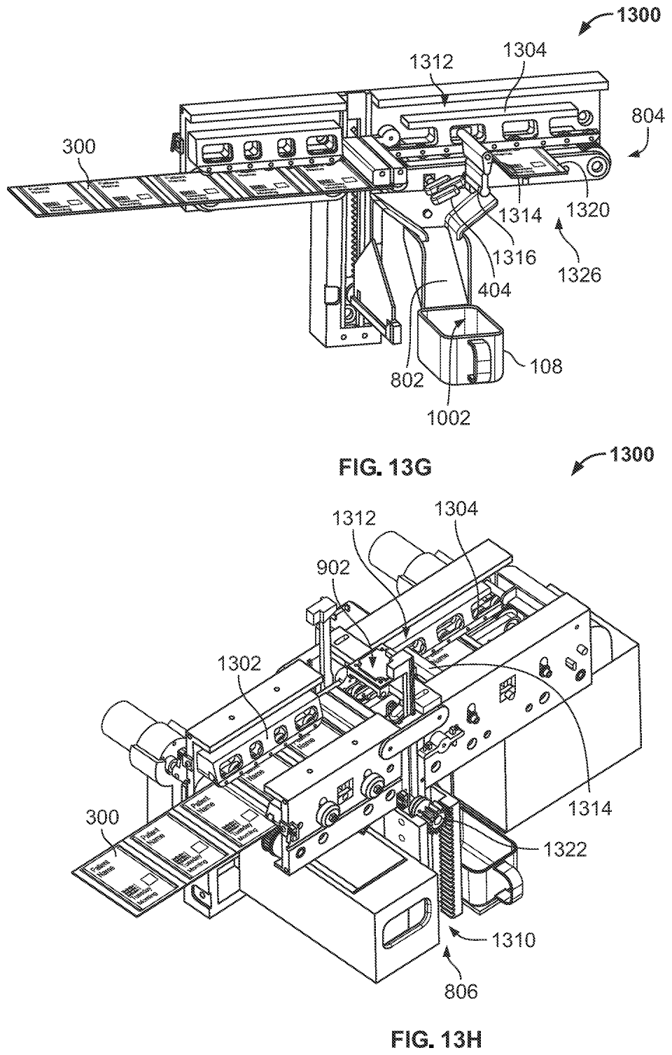

In some embodiments, the vessel 108 comprises a vessel protrusion 1004 extending from a surface defining the vessel cavity 1002. For example, the vessel protrusion 1004 may be a knob, an indent, a grip, or any other protrusion capable of lifting the vessel 108 out of the vessel slot 110. In a non-limiting example, the vessel protrusion 1004 is a handle extending from a first vessel end 1006 to a second vessel end 1008. In some embodiments, the vessel cavity 1002 is recessed in the first vessel end 1006. In some embodiments, the outlet chute 802 has a narrow portion 1010 and a flared portion 1012. In some embodiments, the narrow portion 1010 is located at a position closer to the vessel 108 than the flared portion 1012. In some embodiments, the flared portion 1012 is flared outwards to form a wider end at a location further from the narrow portion 1010. In some embodiments, the vessel 108 comprises a RF-ID tag (See, e.g., FIG. 12).

In some embodiments, the extruder 904 and/or the extruder 702 is located at a position directly above the vessel 108. In some embodiments, the flared portion 1012 of the outlet chute 802 is configured to catch the medicament as is released from the medicament packaging and direct the medicament to the vessel 108.

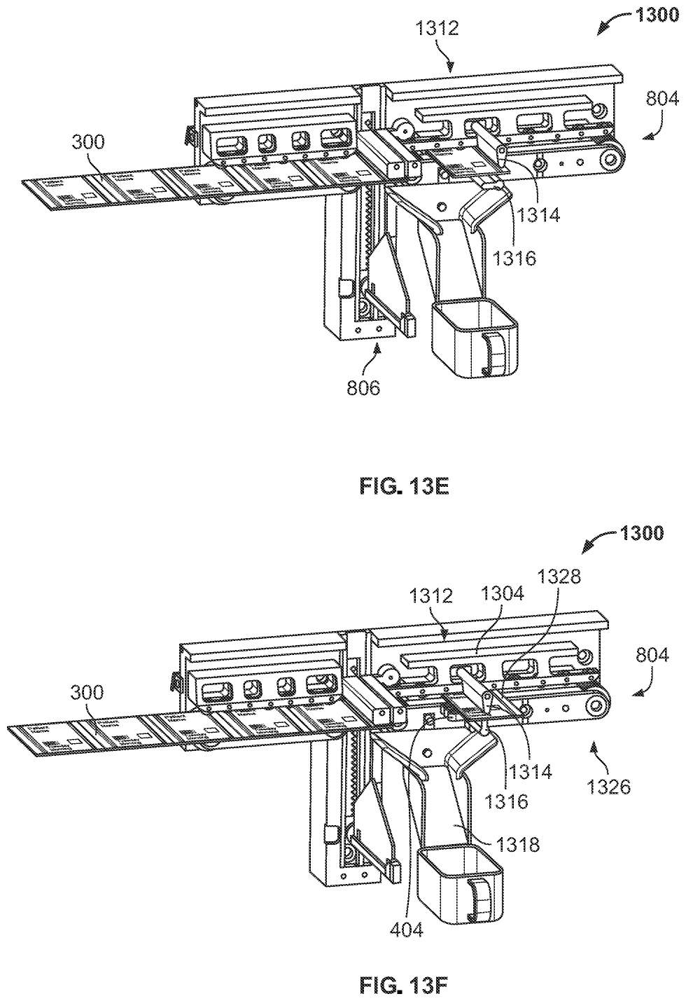

FIG. 11 illustrates a user interface 1100 including user interface display 1102, user interface buttons, and a user interface camera 1104. In some embodiments, the user interface 1100 includes a touch interface on the user interface display 1102. In some embodiments, the user interface 1100 is selected from a group consisting of resistive touchscreens, capacitive touchscreens, surface acoustic wave touchscreens, infrared touchscreens, optical touchscreens, and proximity touchscreens. In some embodiments, the user interface 1100 has a user interface display 1102 facing the user. In some embodiments, the user interface display 1102 is colored.

In some embodiments, the user interface 1100 is configured to display instructions. In a non-limiting example, the user interface 1100 may instruct a user on how to load medicament into the medicament dispensing device 102. In another non-limiting example, the user interface 1100 may be adapted to interact with a user to store or transmit feedback from the user. In some embodiments, the user interface 1100 may include one or more prompts for interaction with the user. In some embodiments, the user interface display 1102 is configured to support a multi-lingual interface and/or pictogram based instructions. In some embodiments, the display is configured to be configurable by a user. For example, the user may be able to select their preferred language.

In some embodiments, the medicament dispensing device 102 comprises a RF tracking system 1106 configured to track a user's movements and/or gestures. For example, the movement may be determined by detecting RF backscatter.

In some embodiments, the RF tracking system 1106 has a RF transmitter. In some embodiments, the RF transmitter is configured to send out radiofrequency signals which reflect off the objects and living beings in an environment. In some embodiments, the detected radiofrequency backscatter data is filtered to remove the static portion of the signal. For example, the static portion may be determined by using differentiation between the frames. The filtered radiofrequency backscatter may be used to determine the motion of people in the proximity of the medicament dispensing device 102 and track their movement. In some embodiments, data is used from multiple domains including computer vision, RFID backscatter, and Wi-Fi backscatter. In some embodiments, the data is used with a machine learning algorithm which recreates the users' gestures while taking medication. In some embodiments, the camera system component is able to identify various body points visible to the camera of the device and extract their movement between frames. In some embodiments, data captured includes users' facial expression, motion of their limbs, and the shape and motion of their hands.

In some embodiments, the user interface 1100 includes one or more user interface buttons. In some embodiments, the buttons are tactile buttons. In some embodiments, the buttons are located adjacent to the user interface display 1102. In some embodiments, the user interface 1100 has a first user interface button 1108a, a second user interface button 1108b, a third user interface button 1108c, and a fourth user interface button 1108d. In some embodiments, the core delivery functions are carried out using the user interface buttons as the primary interface.

In some embodiments, the user interface 1100 comprises a user interface camera 1104. In some embodiments, the user interface camera 1104 faces forwards. In some embodiments, the user interface camera 1104 is used to monitor the movement of a user.

In some embodiments, the medicament dispensing device 102 is equipped with multiple receivers to achieve three-dimensional localization and motion tracking. For instance, the data gathered from the patient's movements may be transmitted to a neural network which may be trained to recognize whether a user has taken the medicament according to the directed schedule.

In some embodiments, the medicament dispensing device 102 comprises a Wi-Fi tracking system based on Wi-Fi signals. In some embodiments, the Wi-Fi tracking system is adapted to track the user's adherence by identifying their movements and gestures via radio reflection backscatter. In some embodiments, radio reflection backscatter is detected by a first set of antennas emitting Wi-Fi signals and a second set of antennas receiving the reflected signals. In some embodiments, the users' gestures and movements are determined using a neural network trained to identify reflected signals which are indicative of specific gestures.

FIG. 12 illustrates a communication system 1200 for a medicament dispensing device 102. In some embodiments, the communication system 1200 comprises an out of band transmitter 1202, an in band transmitter 1204, a vessel 108, and a medicament dispensing device 102. In some embodiments, a vessel 108 includes one or more RF tag 1206. In some embodiments, the RF tag 1206 is frequency agnostic. In some embodiments, the RF tag 1206 is configured to transmit one or more backscatter signal 1208. In some embodiments, the RF tag 1206 is configured to receive a signal from an out of band transmitter 1202. In some embodiments, the RF tag 1206 is configured to receive a signal from an in band transmitter 1204. In some embodiments, at least one of the out of band transmitter 1202 and the in band transmitter 1204 is configured to transmit a signal to the vessel 108. In some embodiments, the in band transmitter 1204 is configured to power the RF tag 1206. In some embodiments, the RF tag 1206 is configured to reflect one or more signals to communicate with the medicament dispensing device 102.

In some embodiments, the medicament dispensing device 102 is configured to receive at least one signal from the RF tag 1206 with a receiver 1210. For example, the medicament dispensing device 102 may receive backscatter signals from the RF tag 1206. In some embodiments, the medicament dispensing device 102 is configured to locate the tag response 1212. The medicament dispensing device 102 may perform a phase signal extraction 1214 from the location of the tag response 1212. The phase signal extraction 1214 may be used to determine one dimensional distance estimates 1216. The phase signal extraction 1214 may be used to perform periodicity candidates 1218. The periodicity candidates 1218 and the one-dimensional distance estimates 1216 may be used to determine a three-dimensional interface 1220. The three-dimensional interface 1220 may be transmitted by the medicament dispensing device 102 to an outbound signal 1222 in order to communicate a three-dimensional location. In some embodiments, the three dimensional interference 1220 uses the one dimensional distance estimates 1216 and generated candidates based on twice the pi periodicity of the phase to determine the most likely three-dimensional location.

In some embodiments, the medicament dispensing device 102 is configured to connect with Wi-Fi and cell connectivity to provide a data link back to a central server. For example, the data link provides communication between a healthcare provider and the user. The information communicated may include medication adherence. In some embodiments, data gathered from the medicament dispensing device 102 is used by the central server to generate reports for healthcare providers. For example, the reports may include the current level of adherence, medicament not taken, and side effects. In some embodiments, software will identify alternative options which can then be sent to healthcare providers in reports.

In some embodiments, the RFID backscatter signals localizes and tracks the motion of the vessel 108 with the RF tag 1206. In some embodiments, the three-dimensional path of the vessel 108 while the user takes or dispenses their medication may be recreated. In some embodiments, the medicament dispensing device 102 is configured to detect Wi-Fi backscatter allows us to track the motion of people and objects in proximity to the medicament dispensing device 102. In some embodiments, motion vectors are constructed to determine the motion of the user while they are taking their medication without relying on tags. In some embodiments, recreating the gestures of the user is used to determine whether they have taken their medication. In some embodiments, the medicament dispensing device 102 uses a combination of RFID and Wi-Fi backscatter signals to detect movement of a user within about an 8 meter radius. In some embodiments, the medicament dispensing device 102 is configured to detect movement of a user through non-metal occlusions.

In some embodiments, the medicament dispensing device 102 interfaces with a convolutional neural network based dynamic behavioral modification and coaching system. In some embodiments, the dynamic behavioral modification and coaching system uses artificial intelligence is to identify which behavioral coaching techniques most engage the user, provide dynamic coaching, and continue to deploy alternative techniques in proportion to the non-adherence rate to increase adherence of taking medicament as directed. For example, if the adherence is low, new, or novel techniques may be deployed more frequently to determine techniques to improves engagement. In some embodiments, if the engagement level is high, the dynamic behavioral modification and coaching system will decrease the number of times new techniques are used. In some embodiments, the frequency of deployment of different techniques and length of time each technique is piloted will be determined by what the AI has learned for users with specific characteristics and adherence rate.

FIG. 13A illustrates a medicament dispensing system 1300 with a medicament packaging 300 partially loaded into a transport mechanism 804. In some embodiments, an opening station 806 is mounted between an infeed conveyer 1302 and an outfeed conveyer 1304. In some embodiments, the platform 912 retains a blade 1306 disposed at a normal angle to the longitudinal axis of the conveyers. For example, the blade 1306 may be mounted vertically relative to the base of the medicament dispensing device 102. In some embodiments, the blade 1306 is driven by a leadscrew and supported on linear bearings. In some embodiments, the blade 1306 is driven by a stepper motor for control over the cutting process. The control of the blade 1306 may be linked to the infeed conveyer 1302, the outfeed conveyer 1304, and camera system 902 to ensure the medicament packaging 300 is in a desired location when cut. For example, a desired location may include the medicament packaging 300 being placed directly over the opening station 806 with no medicament cut by the blade 1306.

In some embodiments, the outfeed conveyer 1304 is configured to transport medicament packaging 300 to an outlet 104. For example, the outlet 104 may be an empty pouch waste bin. In some embodiments, when an unused medicament packaging 300 or a portion thereof is manually fed out of the medicament dispensing device 102, until it passes through to the waste bin. In some embodiments, a user collects the unused medicament packaging 602 from the waste bin.

In some embodiments, the pusher mechanism is a linear drive (vertical) that presses down on the medicament packaging cells as they pass over the unopened medication bin. In some embodiments, when the medicament packaging 300 is at least partially open, the conveyor is stopped and the pusher is activated, forcing the medicament packaging 300 through the conveyor the through an outlet. In some embodiments, the pusher is a leadscrew drive with linear bearings. The leadscrew may be driven by a stepper motor for precise position control.

In some embodiments, a blade 1306 extends from opening station stage 1308 towards the surface of the infeed conveyer 1302 interfacing with the medicament packaging 300. In some embodiments, the blade 1306 is substantially rectangular in shape. In some embodiments, the blade 1306 has a tapered portion tapered towards the medicament packaging 300. In some embodiments, the blade 1306 is configured to be angled down to divert a separated (but still sealed) medicament packaging cell off of the conveyer as it is transported across the opening station 806. For example, the medicament packaging cell may be diverted to a collection bin. The collection bin may be located adjacent to the blade 1306 and/or at a location beneath the infeed conveyer 1302.

FIG. 13B illustrates a medicament dispensing system 1300 with a medicament packaging 300 interfacing with an opening station 806. In some embodiments, the medicament packaging 300 is taken up by the infeed conveyer 1302 of the transport mechanism 804 configured to transport the medicament packaging 300 towards the opening station 806. As shown in FIG. 13B the medicament packaging 300 may be positioned at least partially beneath an opening station stage 1308 of the opening station 806.

FIG. 13C illustrates a medicament dispensing system 1300 with a medicament packaging 300 interfacing with a blade 1306 of an opening station 806. In some embodiments, the medicament packaging 300 is positioned at a desired location interfacing with the opening station 806 by the transport mechanism 804. In some embodiments, the infeed conveyer 1302 will stop when the medicament packaging 300 is in the desired location for cutting.

In some embodiments, the blade 1306 is retained by a platform 912 within an opening station track 1310. In some embodiments, the blade 1306 is moved from a position not interfacing with the medicament packaging 300 to a cutting position to at least partially cut the medicament packaging 300. In some embodiments, the opening station 806 has a guillotine configuration. In some embodiments, the opening station stage 1308 supports the medicament packaging 300 to provide reaction force opposing the cutting force. In some embodiments, the opening station 806 has one of more limit switches and position feedback to allow the system to determine when the blade 1306 is in an open position and when the blade 1306 is in a closed position. For example, an open position is when the opening station 806 is ready to accept a new medicament packaging 300 and the closed position is when the medicament packaging 300 has been entirely cut through by the opening station stage 1308. In some embodiments, the outfeed conveyer 1304 is integrated with the extruder 1312. For example, this integration may adjust restriction of the medicament packaging 300 to permit an empty medicament packaging or an empty medicament packaging cell to pass through, without allowing medicament to pass through.

FIG. 13D illustrates a medicament dispensing system 1300 with a medicament packaging 300 interfacing with an extruder 1312 according to an embodiment described herein. In some embodiments, when the medicament packaging 300 has been at least partially cut by the opening station 806 the medicament packaging 300 is open with medicament inside. In some embodiments, the transport mechanism 804 transports the open medicament packaging 300 containing medicament to the extruder 1312. In some embodiments, the open medicament packaging 300 containing medicament is transferred from the infeed conveyer 1302 to the outfeed conveyer 1304. In some embodiments, a controllable orifice is located in the outfeed conveyer 1304 conveyor. In some embodiments, the controllable orifice opens to allow the medicament packaging 300 to enter and then closes to provide a restriction to push the medicament out of the medicament packaging 300.

FIG. 13E illustrates a medicament dispensing system 1300 with a medicament packaging 300 interfacing with an extruder 1312 and partially extruded by the extruder 1312. In some embodiments, the open medicament packaging 300 containing medicament is transported by the transport mechanism 804 into a desired location to interface with the extruder 1312. In some embodiments, the first cam 1314 and the second cam 1316 are configured to rotate towards the open medicament packaging 300 containing medicament such that eh gap formed between the first cam 1314 and the second cam 1316 is greater than the thickness of the medicament packaging 300 and less than the thickness of the medicament packaging 300 containing medicament.

FIG. 13F illustrates a medicament dispensing system 1300 with medicament 404 partially extruded from a medicament packaging 300 interfacing with an extruder 1312. In some embodiments, an extruder 1312 is positioned adjacent to the outfeed conveyer. In some embodiments, the extruder 1312 is adapted to “squeeze” the medicament packaging 300 to remove the medicament from a partially opened medicament packaging 602. In some embodiments, the extruder 1312 has a pusher, configured to push an unopened medicament packaging cell off of the conveyor into an unopened medication return bin. In some embodiments, the extruder comprises a first cam 1314 and a second cam 1316. In some embodiments, the first cam 1314 and the second cam 1316 close towards one another when an open pouch is passing between the second cam 1316 and the first cam 1314, forcing medication out of the medicament packaging 300 containing medicament 404. In some embodiments, the first cam 1314 and the second cam 1316 are configured to create a restriction around the medicament packaging 300 as it passes along the outfeed conveyer 1304.

FIG. 13G illustrates a medicament dispensing system 1300 with medicament 404 extruded from a medicament packaging 300, the medicament 404 interfacing with an outlet chute 1318. In some embodiments, when the medicament is pushed out of the medicament packaging 300 by the extruder 1312 the medicament 404 falls according to gravity through an outlet chute 1318 and into a vessel cavity 1002 of a vessel 108. The medicament packaging empty of medicament 1320 may be transported by the outfeed conveyer 1304 to an outlet. In some embodiments, the medicament packaging empty of medicament 1320 may be fed out of the medicament dispensing device 102 and into a waste bin. In some embodiments, the extruder 1312 may be configured to remain in an open position allowing the medicament packaging 300 containing medicament to be transported past the extruder 1312 and to an outlet.

FIG. 13H illustrates another view of the medicament dispensing system shown in FIG. 13A. For example, the medicament dispensing system is illustrated in combination with other components of the medicament dispensing compartment 500. In some embodiments, the opening station 806 comprises a gear 1322. In some embodiments, the 1322 is configured to interface with opening station track 1310 to move the blade 1306 in a direction towards the medicament packaging 300. In some embodiments, the medicament dispensing system 1300 comprises a camera system 902. In some embodiments, the camera system 902 is positioned at a location generally above and/or adjacent to the opening station 806.

FIG. 13I illustrates another view of the medicament dispensing system shown in FIG. 13A. For example, the medicament dispensing system is illustrated in combination with other components of the medicament dispensing compartment 500. In some embodiments, the outfeed conveyer 1304 is located adjacent to the outlet 104. In some embodiments, the outlet 104 is a waste container configured to receive medicament packaging empty of medicament 1320. The outlet 104 as a waste container may be detachably coupled to the medicament dispensing device 102. For example, the waste container may be removed to empty out medicament packaging empty of medicament 1320 when the container is full.

### Operating Apparatus

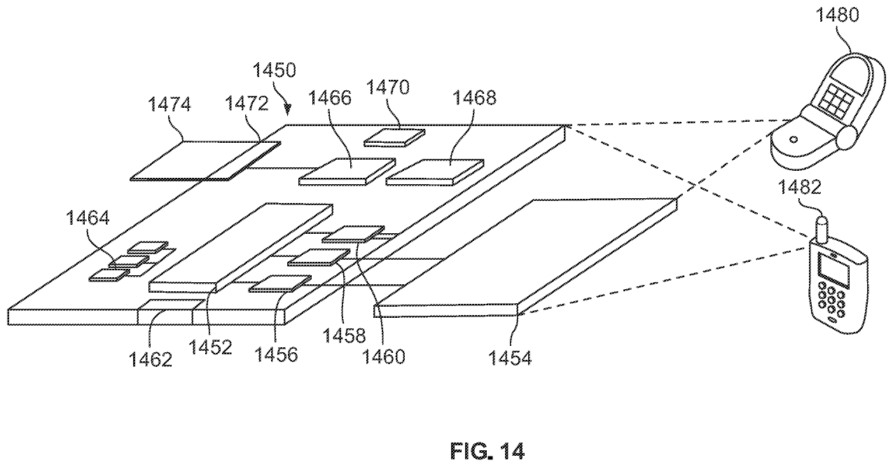

FIG. 14 shows an example of a generic computing device 1450, which may be used with the techniques described in this disclosure. Computing device 1450 includes a processor 1452, memory 1464, an input/output device such as a display 1454, a communication interface 1466, and a transceiver 1468, among other components. The device 1450 may also be provided with a storage device, such as a microdrive or other device, to provide additional storage. Each of the components 1450, 1452, 1464, 1454, 1466, and 1468, are interconnected using various buses, and several of the components may be mounted on a common motherboard or in other manners as appropriate.

The processor 1452 can execute instructions within the computing device 1450, including instructions stored in the memory 1464. The processor may be implemented as a chipset of chips that include separate and multiple analog and digital processors. The processor may provide, for example, for coordination of the other components of the device 1450, such as control of user interfaces, applications run by device 1450, and wireless communication by device 1450.

Processor 1452 may communicate with a user through control interface 1458 and display interface 456 coupled to a display 1454. The display 1454 may be, for example, a TFT LCD (Thin-Film-Transistor Liquid Crystal Display) or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may be provided in communication with processor 1452, so as to enable near area communication of device 1450 with other devices. External interface 1462 may provide, for example, for wired communication in some implementations, or for wireless communication in other implementations, and multiple interfaces may also be used.

The memory 1464 stores information within the computing device 1450. The memory 1464 can be implemented as one or more of a computer-readable medium or media, a volatile memory unit or units, or a non-volatile memory unit or units. Expansion memory 1474 may also be provided and connected to device 1450 through expansion interface 1472, which may include, for example, a SIMM (Single In Line Memory Module) card interface. Such expansion memory 474 may provide extra storage space for device 1450, or may also store applications or other information for device 1450. Specifically, expansion memory 1474 may include instructions to carry out or supplement the processes described above, and may include secure information also. Thus, for example, expansion memory 1474 may be provided as a security module for device 1450, and may be programmed with instructions that permit secure use of device 1450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memory 1474, memory on processor 1452, or a propagated signal that may be received, for example, over transceiver 1468 or external interface 1462.

Device 1450 may communicate wirelessly through communication interface 1466, which may include digital signal processing circuitry where necessary. Communication interface 1466 may in some cases be a cellular modem. Communication interface 1466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1468. In addition, short-range communication may occur, such as using a Bluetooth, WiFi, or other such transceiver (not shown). In addition, GPS (Global Positioning System) receiver module 1470 may provide additional navigation- and location-related wireless data to device 1450, which may be used as appropriate by applications running on device 1450.

Device 1450 may also communicate audibly using audio codec 1460, which may receive spoken information from a user and convert it to usable digital information. Audio codec 1460 may likewise generate audible sound for a user, such as through a speaker, e.g., in a handset of device 1450. Such sound may include sound from voice telephone calls, may include recorded sound (e.g., voice messages, music files, etc.) and may also include sound generated by applications operating on device 1450.

The computing device 1450 may be implemented in a number of different forms, as shown in FIG. 4. For example, it may be implemented as a cellular telephone 1480. It may also be implemented as part of a smartphone 1482, smart watch, personal digital assistant, or other similar mobile device.

### Operating Environment

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

Certain examples of the present disclosure were described above. It is, however, expressly noted that the present disclosure is not limited to those examples, but rather the intention is that additions and modifications to what was expressly described herein are also included within the scope of the disclosed examples. Moreover, it is to be understood that the features of the various examples described herein were not mutually exclusive and may exist in various combinations and permutations, even if such combinations or permutations were not made express herein, without departing from the spirit and scope of the disclosed examples. In fact, variations, modifications, and other implementations of what was described herein will occur to those of ordinary skill in the art without departing from the spirit and the scope of the disclosed examples. As such, the disclosed examples are not to be defined only by the preceding illustrative description.

In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

The foregoing description of examples has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A device for providing a medicament comprising:
a dispensing compartment;
a medicament storage compartment adapted to store a medicament packaging containing the medicament;
a transport mechanism adapted to transport the medicament packaging containing the medicament from the medicament storage compartment to the dispensing compartment;
an opening station disposed within the dispensing compartment and adapted to open the medicament packaging containing the medicament while on the transport mechanism;
an extruder disposed within the dispensing compartment and adapted to remove the medicament from the medicament packaging; and
an outlet from which a user can receive the medicament.

2. The device of claim 1, wherein the dispensing compartment is in fluid communication with the medicament storage compartment.

3. The device of claim 1, wherein the transport mechanism comprises a first conveyer and is adapted to control a position of the medicament packaging on the transport mechanism.

4. The device of claim 3, wherein the transport mechanism comprises a second conveyer adapted to transport the medicament packaging from the dispensing compartment to the medicament storage compartment or to a disposal area.

5. The device of claim 1, wherein the opening station comprises a blade adapted to cut the medicament packaging.

6. The device of claim 5, wherein the opening station comprises a camera system adapted to identify the medicament packaging and ensure the medicament packaging is positioned at a desired location relative to the blade.

7. The device of claim 1, wherein the opening station comprises a camera system adapted to identify the medicament packaging.

8. The device of claim 1, wherein the extruder further comprises a first cam and a second cam.

9. The device of claim 1, further comprising a tray adapted to retain and load into the device the medicament packaging, the medicament packaging selected from a group consisting of a plastic cell multidose sheet and a soft roll multidose pouches.

10. The device of claim 9, wherein the tray is adapted to retain and load into the device the medicament packaging having a 7 day supply or a 28 day supply of medicament.

11. The device of claim 1, further comprising a user interface adapted to interact with the user.

12. The device of claim 1, further comprising a vessel slot having a sensor adapted to detect the presence of a vessel within the vessel slot and to dispense the medicament into the vessel when the vessel is within the vessel slot.

13. A method of using a device for providing medicament, the method comprising the steps of:
obtaining the device comprising a dispensing compartment, a medicament storage compartment adapted to store a medicament packaging containing the medicament, a transport mechanism adapted to transport the medicament packaging containing the medicament from the medicament storage compartment to the dispensing compartment, an opening station disposed within the dispensing compartment and adapted to open the medicament packaging containing the medicament while on the transport mechanism, an extruder disposed within the dispensing compartment and adapted to remove the medicament from the medicament packaging, and an outlet from which a user can receive the medicament;
interacting with the device to indicate a desire to receive medicament; and
receiving the medicament from the outlet.

14. The method of claim 13, further comprising storing the medicament in the medicament storage compartment.

15. The method of claim 14, wherein the dispensing compartment is in fluid communication with the medicament storage compartment.

16. The method of claim 13, further comprising loading the medicament packaging into a tray of the device, wherein the medicament packaging is loaded into a compartment selected from the group consisting of the medicament storage compartment and the dispensing compartment.

17. The method of claim 13, further comprising interacting with a user interface.

18. The method of claim 17, further comprising selecting the medicament to be dispensed from the user interface.

19. The method of claim 17, entering side effects of the medicament into the user interface.

20. The method of claim 13, further comprising:
removing a vessel containing the medicament from a vessel slot;
removing the medicament from the vessel; and
disposing the vessel empty of medicament in the vessel slot.
